(19) United States
(12) Patent Application Publication
(10) Pub. No.: US 2013/0135620 A1
(43) Pub. Date: May 30, 2013

(54) SYSTEMS AND METHODS FOR NON-INVASIVE TESTING OF ELECTROMECHANICAL SYSTEMS DEVICES

(71) Applicants: Wilhelmus A. De Groot, Palo Alto, CA (US); Daniel Felnhofer, San Jose, CA (US)

(72) Inventors: Wilhelmus A. De Groot, Palo Alto, CA (US); Daniel Felnhofer, San Jose, CA (US)

(73) Assignee: QUALCOMM MEMS Technologies, Inc., San Diego, CA (US)

(21) Appl. No.: 13/307,427

(22) Filed: Nov. 30, 2011

(51) Int. Cl. G01N 21/55

(52) U.S. Cl. 356/445

(57) ABSTRACT

This disclosure provides systems, methods and apparatus, including computer programs encoded on computer storage media, for testing an electromechanical systems (EMS) device. In one aspect, a laser is directed at a driven EMS device, and the reflected light pattern is analyzed to provide information regarding the characteristics of the driven EMS device. In some aspects, the reflected light pattern is analyzed to determine a resonant frequency of the EMS device or the damping forces acting on the EMS device. The resonant frequency can then be used to determine stresses within the EMS device, or pressure or temperature within a device package encapsulating the EMS device.

### TECHNICAL FIELD

This disclosure relates to devices and methods for non-invasive testing of electromechanical systems (EMS) devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems (EMS) device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Because of the small scale and complexity of EMS devices such as interferometric modulators, non-invasive methods of testing the EMS devices are useful at multiple stages across the lifetime of the device. In particular, non-invasive methods of testing that can provide information regarding EMS devices sealed within a hermetic package can be used to provide information regarding the state of the device and the surrounding environment without disturbing the hermetic seal, prolonging the lifetime of the EMS device.

### SUMMARY

The systems, methods and devices of the disclosure each have several innovative aspects, no single one of which is solely responsible for the desirable attributes disclosed herein.

One innovative aspect of the subject matter described in this disclosure can be implemented in a testing apparatus for measuring the resonant frequency of an electromechanical systems (EMS) device, the apparatus including a laser emitting device configured to emit a laser beam, a first beam directing optic configured to redirect the laser beam towards an EMS device, a first focusing optic configured to focus the laser beam onto the EMS device, a second beam directing optic configured to redirect a light pattern reflected from the EMS device, and a light detection sensor configured to sense the reflected light pattern.

The apparatus can also include a processor, where the processor is configured to analyze the reflected light pattern sensed by the light detection sensor, and determine a resonant frequency of the EMS device based at least in part on the reflected light pattern. The processor can be further configured to determine a pressure within a package encapsulating the EMS device based at least in part on the resonant frequency of the EMS device. The processor can be further configured to determine a temperature within a package encapsulating the EMS device based at least in part on the resonant frequency of the EMS device.

The second beam directing optic can include an aperture, where the first beam directing optic is configured to direct the laser beam along a first laser path between the first beam directing optic and the EMS device, the first laser path passing through the aperture in the second beam directing optic. The laser emitting device can emit a monochromatic laser beam.

Another innovative aspect of the subject matter described in this disclosure can be implemented in a testing apparatus for measuring the resonant frequency of an electromechanical systems (EMS) device, the apparatus including a laser emitting device configured to emit a laser beam a first beam directing optic configured to redirect the laser beam towards an EMS device, a first focusing optic configured to focus the laser beam onto the EMS device, a second beam directing optic configured to redirect a light pattern reflected from the EMS device, and means for sensing the reflected light pattern.

The sensing means can include a light detection sensor configured to sense the reflected light pattern. The testing apparatus can also include a processor configured to analyze the reflected light pattern sensed by the light detection sensor, and determine a resonant frequency of the EMS device based at least in part on the reflected light pattern. The laser emitting device can emit a monochromatic laser beam.

Another innovative aspect of the subject matter described in this disclosure can be implemented in a method of testing an electromechanical systems (EMS) device to determine a resonant frequency of the EMS device, the method including directing a laser beam at an EMS device, driving the EMS device with a periodic electrical signal to cause movement of at least one portion of the EMS device relative to other portions of the EMS device, varying the frequency of the periodic electrical signal, and analyzing a plurality of light patterns reflected from the EMS device when driven at a plurality of driving frequencies to determine a resonant frequency of the EMS device.

The method can also include sensing the plurality of light patterns reflected from the EMS device with a light detection sensor. Determining the resonant frequency of the EMS device can include determining a frequency response of the EMS device at each of the plurality of driving frequencies based at least in part on the light pattern reflected from the EMS device when driven at each of the plurality of driving frequencies, and determining a resonant frequency based at least in part on the frequency response at each of the plurality of driving frequencies.

The EMS device can be encapsulated within a package, and the method can also include determining at least one of a pressure within the package based on the resonant frequency of the EMS device and a temperature within the package based at least in part on the resonant frequency of the EMS device.

Another innovative aspect of the subject matter described in this disclosure can be implemented in a non-transitory, computer readable storage medium including instructions which, when executed by one or more processors, cause a computer to perform a method including directing a laser beam at an EMS device, driving the EMS device with a periodic electrical signal to cause movement of at least one portion of the EMS device relative to other portions of the EMS device, varying the frequency of the periodic electrical signal, and analyzing a plurality of light patterns reflected from the EMS device when driven at a plurality of driving frequencies to determine a resonant frequency of the EMS device.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a model of an electromechanical systems (EMS) device.

FIG. 10 shows an example of a testing apparatus that can be used to determine a resonant frequency of an EMS device.

FIG. 11 shows another example of a testing apparatus that can be used to determine a resonant frequency of an EMS device.

FIG. 12 shows a detail view of the second beam directing optic of FIG. 11.

FIG. 13 shows an example of a flow diagram illustrating a method of testing an EMS device to determine a resonant frequency of the EMS device.

FIG. 14 shows an example of an EMS device configured for use in a testing process to determine a stress of a layer within the EMS device.

FIG. 15 shows an example of a flow diagram illustrating a method of testing an EMS device to determine a stress within movable component within the EMS device.

FIG. 16 shows an example of a flow diagram illustrating a method of testing an EMS device to determine the stress within a movable component of the EMS device.

FIG. 17 shows an example of a flow diagram illustrating a method of testing an EMS device to determine the pressure to which the EMS device is exposed.

FIG. 18 shows an example of a flow diagram illustrating a method of testing an EMS device to determine the temperature within a package encapsulating an EMS device.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Systems and methods are provided for non-invasive measurement of various characteristics of electromechanical systems (EMS) devices through the use of a laser directed at or adjacent an EMS device being driven by a periodic driving voltage. In some implementations, an EMS device driven by a periodic driving voltage will result in back and forth motion of a movable component of the EMS device relative to a substantially fixed component of the EMS device. Light reflected off the EMS device will undergo constructive and/or destructive interference due to the phase delay introduced by displacement of the movable component of the EMS device relative to a fixed component, and the far field intensity of the reflected light will be directly related to the amount of displacement. The reflected light pattern can be directed towards a light detector, which can analyze one or both of the intensity and the phase shift of the response.

When the frequency of the driving voltage is varied across a range of frequencies, the reflected light response at each of the driving frequencies can be analyzed to identify a resonant frequency of the EMS device or a damping force acting on the EMS device. The resonant frequency or damping forces can then be used to provide information regarding a characteristic of the EMS device. For example, the resonant frequency can be used to determine a stress of a film, a film stack, or a plurality of films within the EMS device. The resonant frequency can also be used in conjunction with calibration information to determine the pressure to which the EMS device is exposed, or to determine the temperature within a package encapsulating the EMS device.

Particular implementations of the subject matter described in this disclosure can be implemented to realize one or more of the following potential advantages. The systems and methods discussed herein allow accurate, non-invasive measurement of EMS devices. In addition, the measurements can be performed through a display substrate or other substrate, allowing the measurement of characteristics of EMS devices hermetically sealed within packages without disturbing the hermetic seal. The measurements can also be performed with respect to a single EMS element or a plurality of EMS elements within an array of EMS elements, and allow for measurement of multiple locations within the EMS array by redirecting the laser to the portions of the EMS array to be tested. The systems and methods discussed herein also allow very accurate measurement of properties such as pressure and temperature, and allow direct measurement of stress within one or more films within the EMS device.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

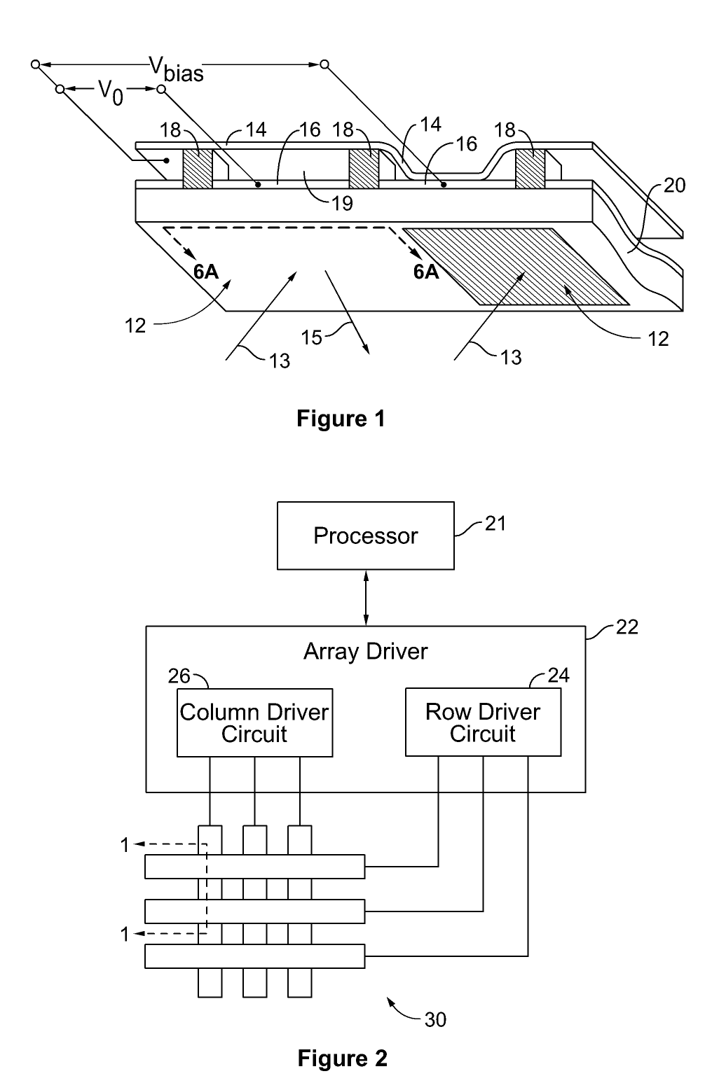

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

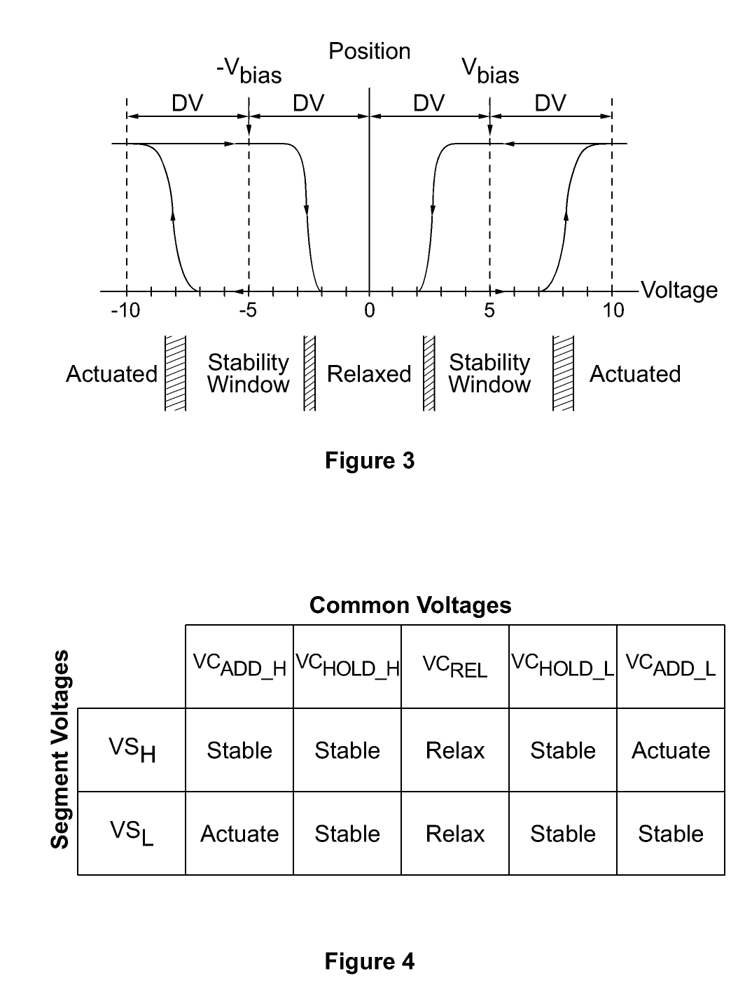

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

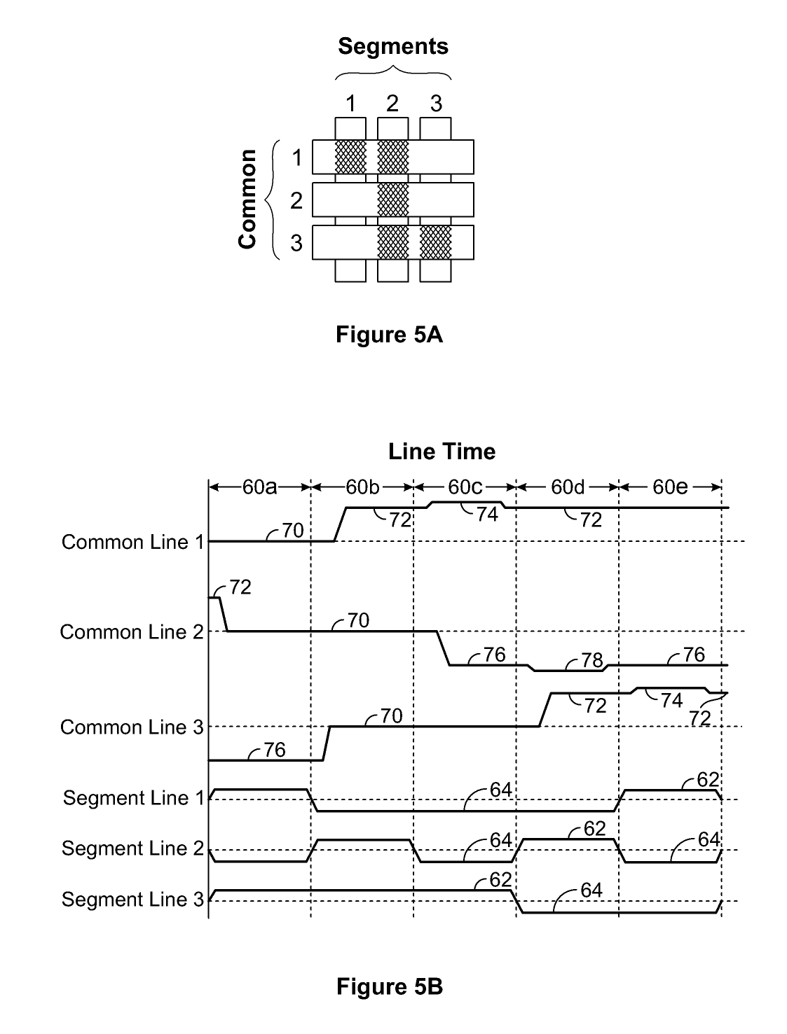

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

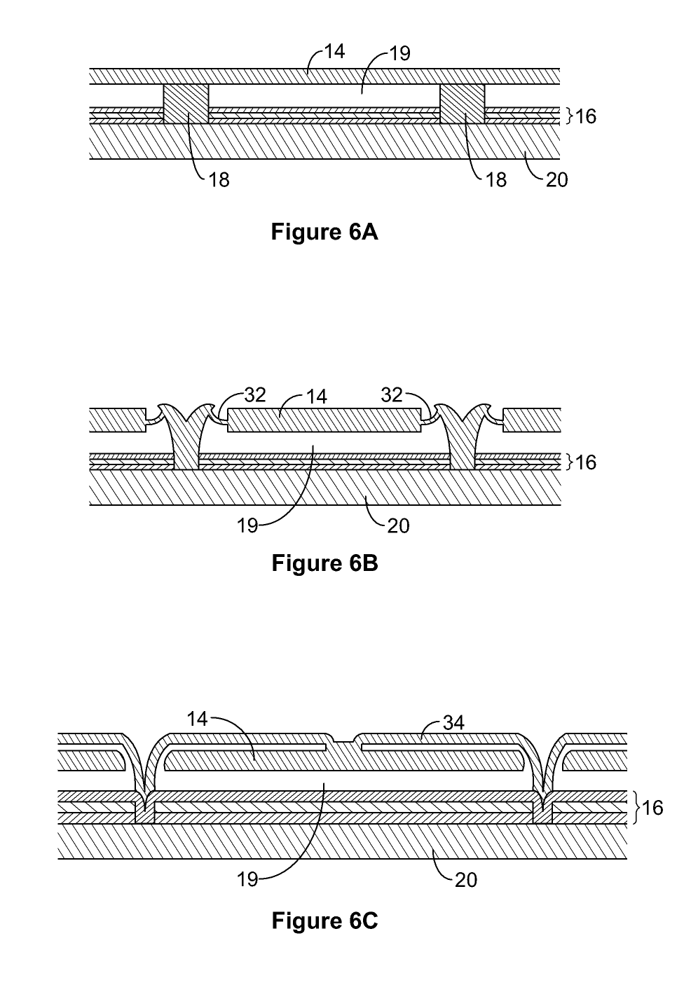

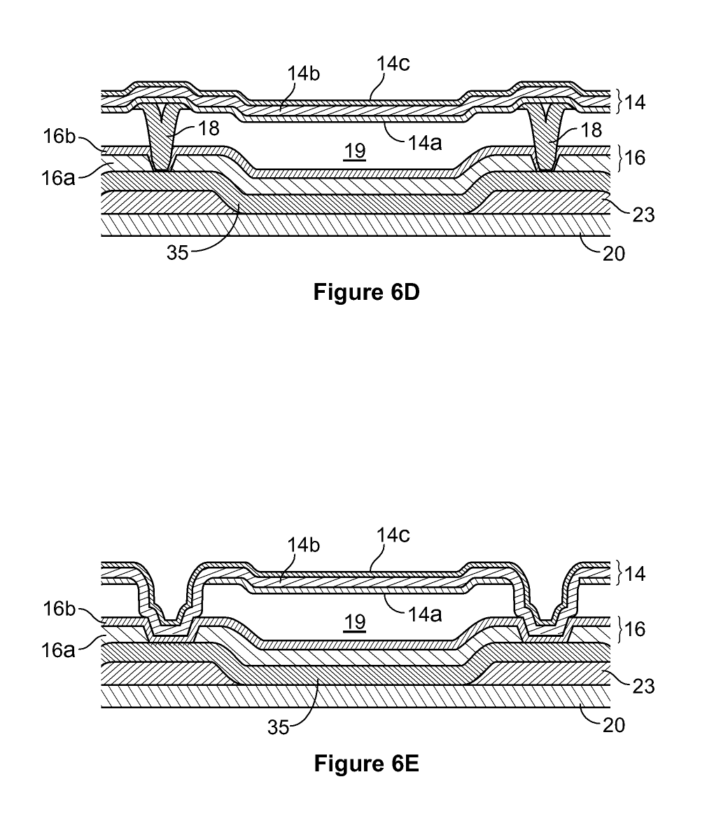

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

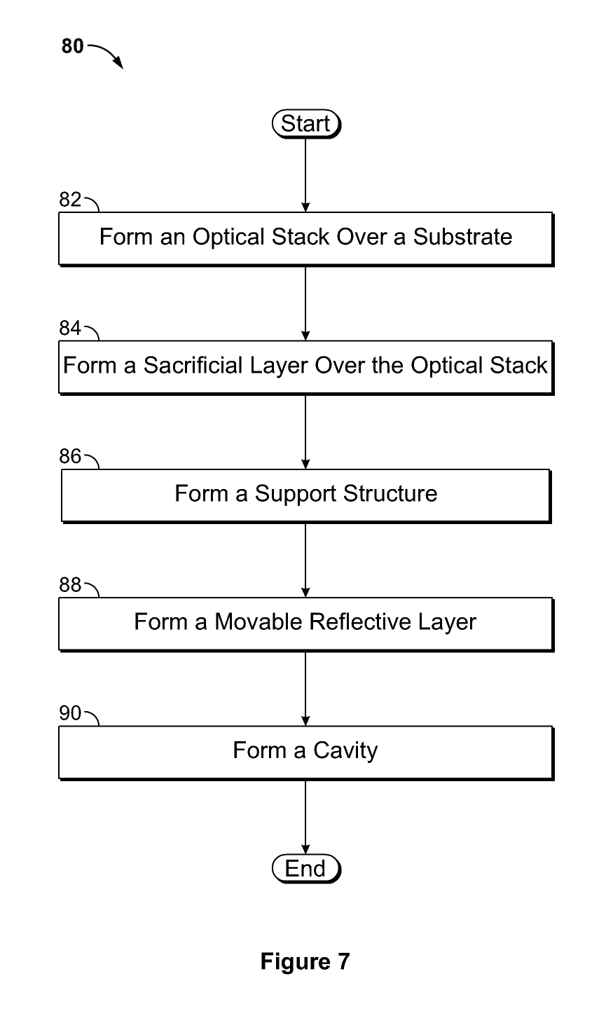

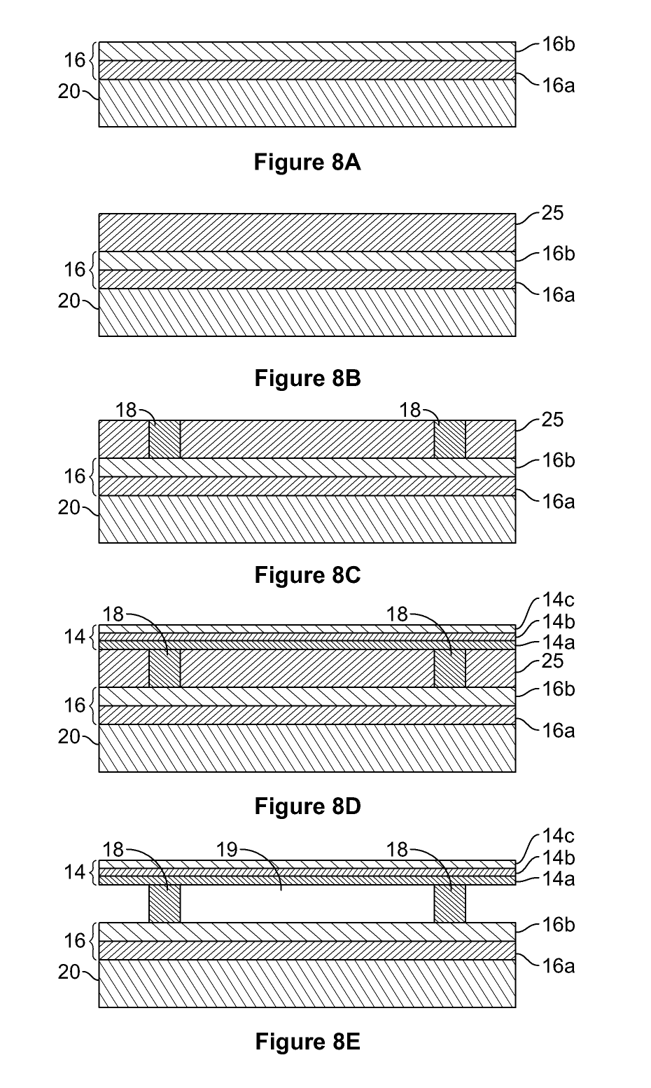

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

The dynamic behavior of an electromechanical (EMS) device in response to a driving voltage is dependent upon both the structure of the EMS device itself and the environment in which the EMS device is located. For example, both the resonant frequency and the amount of damping on the EMS device are affected by factors such as the stress within a movable component of the EMS device and the pressure to which the EMS device is exposed. The resonant frequency of an EMS device can therefore be used, either by itself or in conjunction with additional information or measurements, to provide information about several aspects of the EMS device and its surrounding environment. Information regarding the damping force acting on the EMS device can also be used similarly.

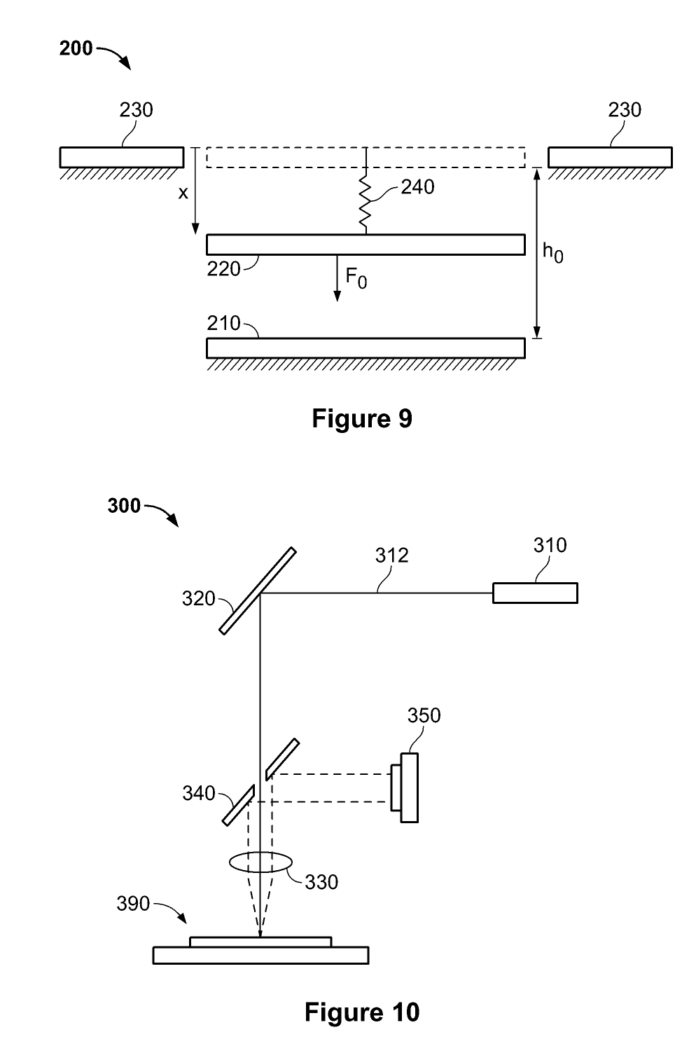

FIG. 9 shows an example of a model of an EMS device. The EMS device 200 includes a movable or displaceable component 220, and a fixed component 230. The EMS device 200 may, in some implementations, be an interferometric modulator such as, for example, those discussed above with respect to FIGS. 6A-6E or FIG. 8E. In other implementations, the EMS device 200 may be another type of EMS device which has a movable component which is displaceable with respect to other components of the EMS device. The EMS device 200 need not be an optical or display device, but may be, for example, a MEMS switch or other non-optical EMS device.

For convenience and consistency, the EMS device may be described herein as including certain components of interferometric modulators discussed above, although other EMS devices may include different or additional components. In an implementation in which the EMS device 200 is an interferometric modulator such as the modulator of FIG. 8E, the movable component 220 may, for example, correspond to the portions of the movable layer 14 located between support structures 18, and the fixed component 230 may correspond to the portions of the movable layer 14 overlying the support structures 18 (see FIG. 8E). Although described herein with respect to an interferometric modulator viewed from the back, or “process,” side of the interferometric modulator, the fixed and movable components may also be surfaces viewable from the display side of the interferometric modulator.

The movable component 220 may be displaced a distance x from a resting position by application of an electrostatic force Fₑₗ caused by application of a potential difference between the movable component 220 and an electrode 210. Electrode 210 may be a fixed electrode such as the conductive absorber 16a of the interferometric modulator of FIG. 8E. A restoring force acting on the movable component 220 may be modeled as a spring 240 having a spring constant k₀.

In addition to the effect of the restoring force of the membrane, EMS devices 200 will experience additional resistance when driven in a non-vacuum environment, due to squeeze film damping. Squeeze film damping occurs when movement of the movable component 220 towards the electrode 210 results in evacuation and/or compression of the gas located in the cavity between the movable component 220 and the fixed electrode 210. Similarly, movement of the movable component 220 away from the electrode 210 results in expansion of the gas within the cavity and/or intake of additional gas to fill the increased size of the cavity. For example, when the movable component 220 is a square plate, such as in a parallel plate capacitor, a dimensionless squeeze number σ representative of the effect of squeeze film damping for a given system can be defined as follows:

$$σ = \frac{12 {μ}_{g} ω {l}^{2}}{{P}_{a} {h}_{0}^{2}} , \qquad ( 1 )$$

where Pₐ is the pressure of the gas, μ_{g} is the viscosity of the gas, l is the characteristic length of the plate, ω is the driving frequency, and h₀ is the gap height at equilibrium. Similar squeeze numbers can be derived for plates of different shapes, such as rectangular or trapezoidal plates. The frequency and amplitude at which the EMS device 200 is driven will determine whether the resistance is due primarily to expansion/compression of gas or introduction/evacuation of gas. For each EMS device 200, a critical frequency ω_{c} can be identified based on the properties of both the ambient gas and the structure of the EMS device 200. For a EMS device 200 having a movable component in the form of a square plate, the critical frequency ω_{c} can be estimated as:

$${ω}_{c} = \frac{{π}^{2} \cdot {P}_{a} \cdot {h}_{0}^{2}}{6 \cdot {μ}_{g} \cdot {l}^{2}} . \qquad ( 2 )$$

For driving frequencies below the critical frequency ω_{c}, the movable component 220 moves slowly enough that there is sufficient time for air to be sucked into and pushed out of the cavity as the gap size changes. At these lower driving frequencies, viscous damping of the membrane will be the dominant effect on the behavior of the device, and the viscous damping will be proportional to the velocity of the movable component 220. For driving frequencies above the critical frequency ω_{c}, the movable component 220 moves quickly enough that there the air cannot escape or be pulled into the cavity, and the air is instead compressed and expanded as the movable component 220 moves. At these higher driving frequencies, elastic damping of the membrane will be the dominant effect on the behavior of the device, and the elastic damping will be proportional to the displacement of the movable component 220.

For high aspect ratio EMS devices such as interferometric modulators, the gap height h₀ at equilibrium will typically be small compared to the characteristic length/of the movable component 220. Such devices will typically have a resonant frequency ωₐ which is well above the critical frequency ω_{c}, and the gas between the movable component 200 and the electrode 210 will effectively increase the stiffness of the movable component 200, altering the resonant frequency ωₐ of the EMS device 200. In particular, where the EMS device 200 is operated at high driving frequencies near the resonant frequency, the effect of the squeeze film damping on the EMS device 200 can be modeled as another spring having a spring constant kₑ, operating additively with the spring constant k₀, such that the spring 240 of FIG. 9 has an effective spring constant equal to kₑ+k₀. The value of spring constant kₑ is a function of the squeeze number σ and given by the following relationship:

$${k}_{e} ( σ ) = \frac{64 {σ}^{2} {P}_{a} {l}^{2}}{{π}^{8} {h}_{0}} {\sum }_{m , n = odd}^{ } \frac{1}{{( mn )}^{2} [ {( {m}^{2} + {n}^{2} )}^{2} + {σ}^{2} / {π}^{4} ]} . \qquad ( 3 )$$

When the EMS device 200 is driven by a periodic voltage having a driving frequency ω, the motion of the system is given by the following balance of forces:

$$m \frac{{d}^{2} x}{d {t}^{2}} + {c}_{d} \frac{d x}{d t} + ( {k}_{0} + {k}_{e} ) x = F ( t ) , \qquad ( 4 )$$

where m is the mass of the movable component, c_{d} is a damping constant, and F(t) is the electrostatic force acting on the EMS device 200 as a function of time. When the EMS device 200 is a parallel plate capacitor, and the static component is ignored, the equation of motion is given by:

$$m \frac{{d}^{2} x}{d {t}^{2}} + {c}_{d} \frac{d x}{d t} + ( {k}_{0} + {k}_{e} ) x = {F}_{0} cos ( ω t ) . \qquad ( 5 )$$

The steady state response gives the following value for the displacement x:

$$\begin{matrix}x = A cos ( ω t + φ ) , \\ where \text{:} & ( 6 ) \\ A = \frac{{F}_{0}}{m} \sqrt{\frac{1}{{( {ω}_{a}^{2} - {ω}^{2} )}^{2} + {c}_{d}^{2} {ω}^{2} / {m}^{2}}} , & ( 7 ) \\ φ = - arc tan \frac{{c}_{d} ω}{m ( {ω}_{a}^{2} - {ω}^{2} )} , \\ and & ( 8 ) \\ {ω}_{a}^{2} = ( {k}_{0} + {k}_{e} ) / m = {ω}_{0}^{2} + {k}_{e} / m . & ( 9 )\end{matrix}$$

In the above relationships, Fₒ is a constant representing the magnitude of the electrostatic force, φ is the phase shift between the driving force and the measured response, ω₀ is the resonant frequency of the EMS device 200 in the absence of squeeze film damping, and ωₐ is the resonant frequency of the EMS device 200. Note that the above relationships are applicable for a range of displacement x which is less than roughly ⅓ of the distance h₀ between the movable component 220 in an unactuated position and electrode 210, as electrostatic forces which cause additional displacement may cause the movable component 220 of the EMS device to snap down against the electrode 210. With that constraint, and based on the above relationships, the resonant frequency of the EMS device 200 can be determined in at least two different ways. It can be seen that the amplitude of the response, or the displacement x, will have a peak as the frequency of the driving force, ω, matches the resonant frequency ωₐ of the EMS device. Alternately, the resonant frequency can be identified based upon the phase shift φ between the driving force and the measured response. As the frequency of the driving voltage increases from a frequency well below the resonant frequency to a frequency well above the resonant frequency, the phase shift φ first increases from 0° to 90°, and undergoes a 180° phase shift at resonance after which φ will be −90° just above the resonant frequency ωₐ. Increasing driving frequency will result in the phase shift gradually returning to 0°.

Because the magnitude of the squeeze film damping is dependent in part upon the pressure of the gas being compressed, an increase in gas pressure will increase the effective stiffness of the movable component 220, increasing the resonant frequency of the device. Thus, a change in the resonant frequency of an EMS device provides an indication of the gas pressure to which an EMS device 200 is exposed. Similarly, an increase in the temperature of an EMS device 200 will alter the resonant frequency of the device. An increase in temperature could soften the mechanical layer, reducing the stiffness and therefore the resonant frequency of the device. This softening of the mechanical layer will occur if the thermal coefficient of expansion of the mechanical layer is higher then that of the substrate. However, if the EMS device 200 is sealed within a package, an increase in temperature will also increase the gas pressure within the package, increasing the effective stiffness of the layer due to an increase in the effect of squeeze film damping. For a sealed package, the increase in effective stiffness due to the pressure increase will outweigh the decrease in stiffness due to the softening of the movable layer.

When light of a wavelength λ is incident upon the EMS device 200, and the movable component 220 is displaced from the fixed component 230 by a distance x, a first beam of light reflecting off of the movable component 220 will have a relative phase delay compared to a second beam of light reflecting off of the fixed component 230. In an implementation where the light is incident in a direction substantially normal to the surfaces of the movable component 220 and the fixed component 230, these beams will interfere to an intensity I in the far field given by the following relationship:

$$I = {I}_{1} + {I}_{2} + 2 {( {I}_{1} {I}_{2} )}^{1 / 2} cos ( \frac{4 π x}{λ} ) , \qquad ( 10 )$$

where I₁ is the intensity of the first beam and I₂ is the intensity of the second beam. Where the reflectance of the movable component 220 and the fixed component 230 are similar to one another, and I₁ is equal to I₂, the relationship simplifies further to:

$$I = 4 {I}_{1} \cdot {cos}^{2} ( \frac{4 π x}{λ} ) . \qquad ( 11 )$$

Thus, it can be seen from Equations (10) and (11) that the intensity of the reflected light is a direct measure of the displacement x of the movable component 220 relative to the fixed component 230. A similar relationship can be derived for more complex implementations in which there are multiple movable and/or fixed components which have different resting positions relative to one another, such as a multicolor interferometric modulator array in which the movable components of interferometric modulators of different colors may come to rest at different heights in their unactuated states. In an implementation in which there are three components at different heights, a first beam having an intensity I₁ is reflected off the first component, a second beam of light having an intensity I₂ is reflected off the second component, and a third beam of light having an intensity I₃ is reflected off the third component. The difference in height between the first component and the second component is given by Δ₁₂, the difference in height between the first component and the third component is given by Δ₁₃, and difference in height between the second component and the third component is given by Δ₂₃. In an implementation in which only the first is being driven, the difference in height between the second and third component Δ₂₃ may remain constant, so long as the driving of the first component does not introduce movement in one of the other components. The far field intensity I of the reflected light pattern in such an implementation may be given by:

$$I = {I}_{1} + {I}_{2} + 2 \sqrt{{I}_{1} {I}_{2}} cos ( 2 π \frac{2 Δ {x}_{12}}{λ} ) + 2 \sqrt{{I}_{1} {I}_{3}} cos ( 2 π \frac{2 Δ {x}_{13}}{λ} ) + 2 \sqrt{{I}_{1} {I}_{3}} cos ( 2 π \frac{2 Δ {x}_{23}}{λ} ) . \qquad ( 12 )$$

FIG. 10 shows an example of a testing apparatus that can be used to determine a resonant frequency of an EMS device. The testing apparatus 300 includes a laser emitting device 310 configured to emit a laser beam along a path 312 towards a first beam directing optic 320. In one implementation, the laser emitting device 310 includes a monochromatic laser configured to emit light of a particular wavelength λ, and the first beam directing optic 320 includes a dichroic reflector configured to reflect a substantial portion of incident light of wavelength λ, while permitting a substantial portion of light of other wavelengths to pass therethrough.

The first beam directing optic 320 is configured to direct the laser beam along a path 314 towards a focusing optic 330 which is configured to focus the laser beam on a specific portion of an electromechanical systems (EMS) device 390. The incident laser beam is reflected from the EMS device 390 in a light pattern which is indicative of the relative position of certain portions of the EMS device relative to one another, and back through the first focusing optic 330. In particular, when the light source is a monochromatic layer, the reflected light pattern may vary in intensity across the pattern, forming a reflected light intensity pattern. In other implementations, light sources which are not substantially monochromatic may alternately be used, and other aspects of the light pattern such as wavelength, may be analyzed. After the reflected light pattern passes back through the first focusing optics 330, the light is reflected by second beam directing optics 340 towards a light detecting sensor 350. In one implementation, the second beam directing optics 340 include a reflector having an aperture formed therein which allows the laser beam to pass therethrough before impinging on the EMS device 390.

In one implementation, the EMS device 390 is an EMS device having a component which is movable relative to a substantially fixed component, such as EMS device 200 of FIG. 9. As discussed with respect to FIG. 9, when the EMS device 390 is driven by an appropriate periodic driving voltage, a movable component of the EMS device 390 is driven back and forth relative to a fixed component of the EMS device 390. The displacement of the movable component relative to the fixed component results in a relative phase delay between a beam of light reflected off of the movable component and a beam of light reflected off of the fixed component. This relative phase delay results in constructive-destructive interference, altering the far field intensity of the reflected light. The reflected light pattern can be measured using the light detecting sensor 350 and the intensity or other properties of the light can be analyzed to provide an indication of the relative displacement between the movable component and the fixed component. Similar measurements can be taken over a range of driving frequencies, and the measurements analyzed to identify the resonant frequency of the driven EMS device 390.

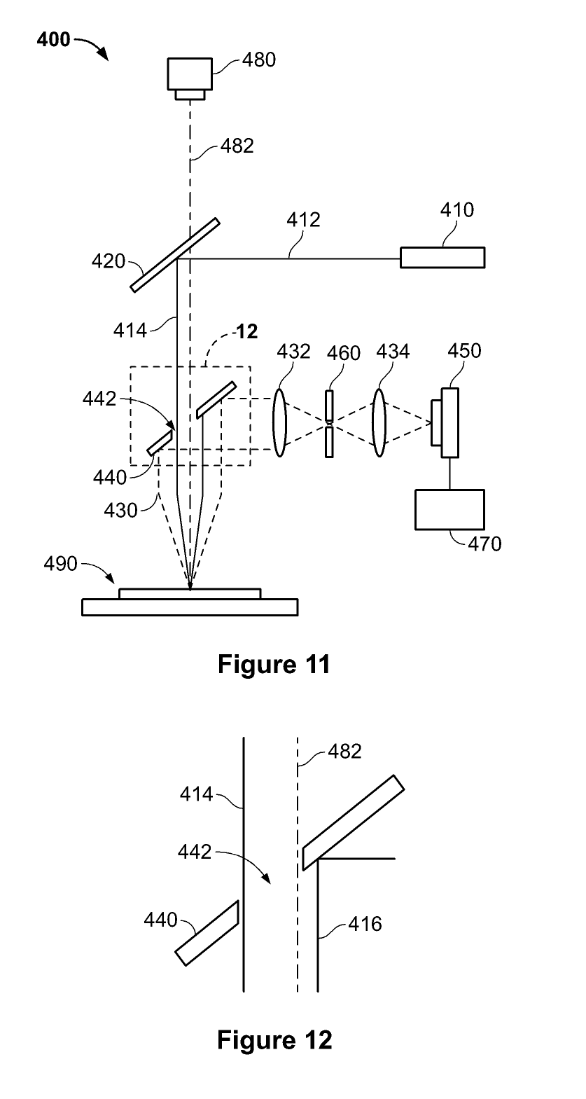

FIG. 11 shows another example of a testing apparatus that can be used to determine a resonant frequency of an EMS device. The testing device 400 of FIG. 11 is similar in structure to the testing device 300 of FIG. 10, but includes certain additional components not depicted in the testing device 300 of FIG. 10. Testing device 400 is a laser emitting device 410 configured to emit a laser beam along a path 412 towards a first beam directing optic 420. In one implementation, the laser emitting device includes a monochromatic diode laser configured to emit light having a wavelength of roughly 650 nm, and the first beam directing optic 420 is a dichroic reflector configured to reflect a substantial portion of incident light having a wavelength of about 650 nm. In one particular implementation, the first beam directing optic 420 is a 45° red reflector available from THORLABS as product FM02, which reflects roughly 90% of light in the wavelength range of 610-725 nm, and transmits roughly 85% of light in the wavelength range of 400-550 nm.

The first beam directing optic 420 is configured to redirect the laser beam along a path 414 towards a first focusing optic 430 which is configured to focus the laser beam on a specific portion of an electromechanical systems (EMS) device 490. As can be seen in FIG. 11, and as will be described further below with respect to FIG. 12, the path 414 of the laser beam passes through an aperture 442 in a second beam directing optic 440 before passing through the first focusing optic 430. In one implementation, the first focusing optic is an achromatic lens with a focal length of roughly 100 mm.

The incident laser beam is reflected from the EMS device 490 and back through the first focusing optic 430 in a light pattern which is indicative of the relative position of certain portions of the EMS device relative to one another. The light pattern is then reflected by the portions of the second beam directing optic 440 which surround the aperture 442, and towards a second focusing optic 432.

The second focusing optic 432 directs the reflected light pattern through a filter 460. In the illustrated implementation, the filter 460 is a pinhole, although alternate filtering structures may also be used. In one implementation, the filter 460 may include an aperture having an adjustable size. The filter 460 can be used to filter out non-collimated light and higher order interference modes, improving the signal-to-noise ratio of the reflected light pattern. After passing through the filter 460, the reflected light pattern is directed through a third focusing optic 434 which condenses the light pattern onto the light detector 450. In one implementation, the light detector 450 is a silicon switchable gain detector available from THORLABS as product PDA36A, although other suitable light detectors may also be used.

The light detector may be in electrical communication with a processor 470 which is configured to analyze an aspect of the reflected light pattern. As discussed above, a determination of resonant frequency may in some implementations include identification of a driving frequency which results in a peak intensity of the reflected light pattern. The processor 470 may be configured to record the peak intensity of the reflected light pattern for each of a plurality of driving frequencies and store them for later analysis. In other implementations, a phase shift between the driving force and the light pattern response may be measured, corresponding to the phase shift between the driving force and the movement of the movable component of the EMS device 490 in response to the driving force. This phase shift information may be determined for each of a plurality of driving frequencies, and stored for later analysis.

The testing device 400 may also include a camera 480 aligned along a camera axis 482 extending between the camera and the electromechanical device. In one implementation, the camera axis 482 extends parallel to but offset from the beam path 414. In one implementation, the camera axis passes through the focal point of first focusing optic 430. Although the first beam directing optic 420 is disposed along the camera path 482 between the camera 480 and the EMS device 490, the use of a dichroic reflector as the first beam directing optic 420 allows the transmission of certain wavelengths of light through the first beam directing optic 420, such that the camera 480 can view the EMS device 490 through the first beam directing optic 420. The camera 480 can be used to align the testing device 400 with a particular portion of the EMS device 490 to be tested, and can also be used to record visual information during the testing process. In some implementations, the EMS device 490 may be an array of individual EMS elements, and the camera 484 can be used to align the testing device 400 with a particular EMS element or group of EMS elements to be tested.

In addition to directing the laser beam at a particular portion of the EMS device 490, control over the specific portion of the EMS device 490 being tested may also be provided by varying the spot size of the laser incident on the EMS device 490. In one implementation, the first focusing optic 430 may be mounted to allow translation of the first focusing optic 430 along the path 414 of the laser beam to change the distance between the first focusing optic 430 and the EMS device 490, focusing or defocusing the laser. In an implementation in which the EMS device 490 is an array of individual EMS elements, the spot size of the laser may be varied to test either a single EMS element or a plurality of adjacent EMS elements simultaneously.

FIG. 12 shows a detail view of the second beam directing optic of FIG. 11. In particular, it can be seen in FIG. 11 that the second beam directing optic 440 includes an aperture 442 extending therethrough, and that both the camera axis 482 and the beam path 414 of the laser beam pass through the aperture 442. In one implementation, the second beam directing optic 440 is a contiguous structure having an aperture 442 formed therethrough. In other implementations, the second beam directing optic 440 may include two or more components, with the aperture 442 formed by a space between the two or more components.

As can be seen in FIG. 12, the camera path 482, which also passes through the center of first focusing lens 430, is offset from a center of the aperture 442 to one side of the aperture, and the beam path 414 is offset from a center of the aperture 442 to the opposite side of the aperture. In an implementation in which the camera path 482 extends through a focal point of the focusing optic 430, the beam path 414 will be offset from the focal point of the focusing optic 430, and will impinge the electromechanical device 490 at a slight angle to the normal. Although the reflected light pattern may be wider than the width of the beam, much of the reflected light will be reflected back at a similar angle, and will be reflected back along a path 416 on the opposite side of the camera path 482 from the beam path 414. Thus, because the center of the aperture 442 is offset from the camera path 482, a substantial portion of the reflected light pattern strikes a surface of the second beam directing optic 440, rather than passing back through the aperture 442.

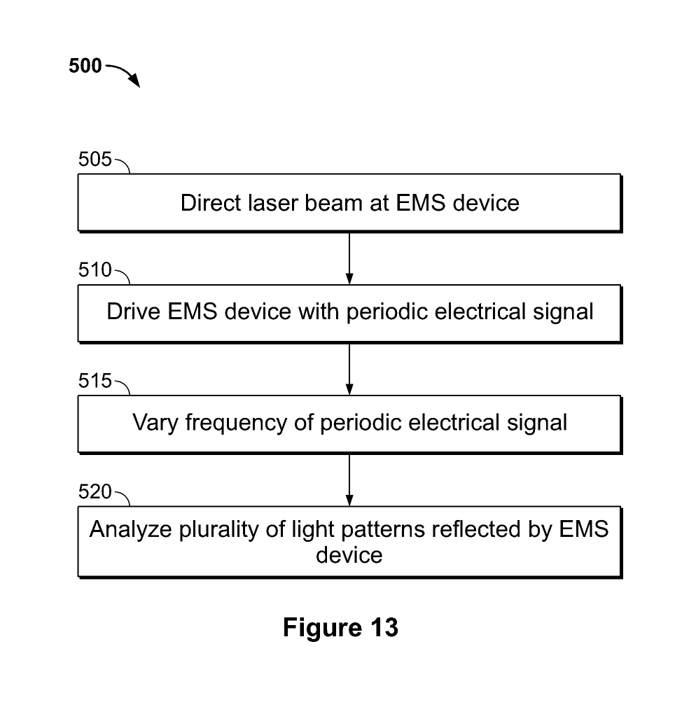

FIG. 13 shows an example of a flow diagram illustrating a method of testing an EMS device to determine a resonant frequency of the EMS device. The method 500 begins at a block 505, where a laser beam is directed at an EMS device to be tested. In some implementations, the laser beam may be directed at the EMS device using a testing device such as testing devices 300 and 400 of FIGS. 10 and 11, respectively, although any other suitable testing device may be used in other implementations.

The method 500 then proceeds to a block 510, where the EMS device to be tested is driven by a periodic electrical signal. As discussed above, the periodic driving electrical signal causes a movable component within the EMS device to move relative to a substantially fixed component within the EMS device, resulting in a phase delay between light reflected off of the fixed component and light reflected off the movable component. This phase delay alters a light pattern reflected from the EMS device. This reflected light pattern can be directed to a light detector, where an aspect of the reflected light pattern can be measured.

The method 500 then proceeds to a block 515 where the frequency of the periodic electrical signal is varied. In particular, the frequency of the periodic electrical signal can be varied over a selected range, and an aspect of the reflected light pattern can be measured at each frequency. For example, the maximum intensity of the reflected light pattern, representing the greatest displacement of the movable component relative to the fixed component, may be recorded for each particular driving frequency. In another implementation, the phase shift between the driving force and the response of the movable component may be measured. The step size between frequencies can be selected to provide a desired level of accuracy in determining the resonant frequency of the EMS device.

The method 500 then proceeds to a block 520 where the plurality of light patterns reflected from the EMS device when driven at the plurality of driving frequencies are analyzed to determine a resonant frequency of the EMS device. As discussed above, in one implementation, the driving frequency which results in the peak intensity of the reflected light pattern is identified as the resonant frequency of the EMS device. In another implementation, the frequency at which phase shift between the driving force and the measured response flips from +90° to −90°, or from leading to lagging signal response is identified as the resonant frequency of the EMS device.

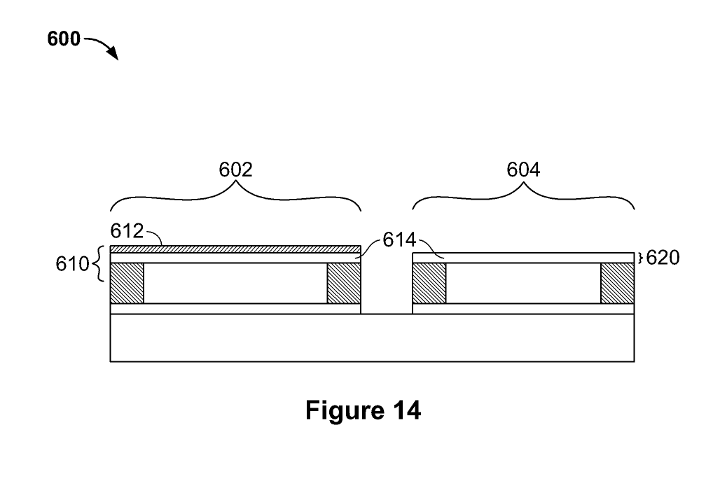

FIG. 14 shows an example of an EMS device configured for use in a testing process to determine a stress of a layer within the EMS device. The EMS device 600 includes a first region 602 and a second region 604. In the first region 602, a movable component 610 of the EMS device includes a layer 612 to be tested, along with one or more additional layers 614. In the second region 604, a movable component 620 is substantially identical to the movable component 610 within the first region 602, except that the movable component 620 does not include the layer 612 to be tested. In one implementation, the first region 602 includes one or more EMS elements including the layer 612, and the second region 604 includes one or more EMS elements omitting the layer 612. The stress σ within the film 612 to be tested can be calculated based on the following relationship:

$$σ = \frac{4 L}{tW} ( {m}_{1} \cdot {ω}_{1}^{2} - {m}_{2} \cdot {ω}_{2}^{2} ) , \qquad ( 13 )$$

where t, L, and W are the thickness, length, and width, respectively, of the layer 612, m₁ is the mass of the movable component 610 which includes the layer 612, m₂ is the mass of the movable component 620 which omits the layer 612, ω₁ is the resonant frequency of the movable component 610, and ω₂ is the resonant frequency of the movable component 620.

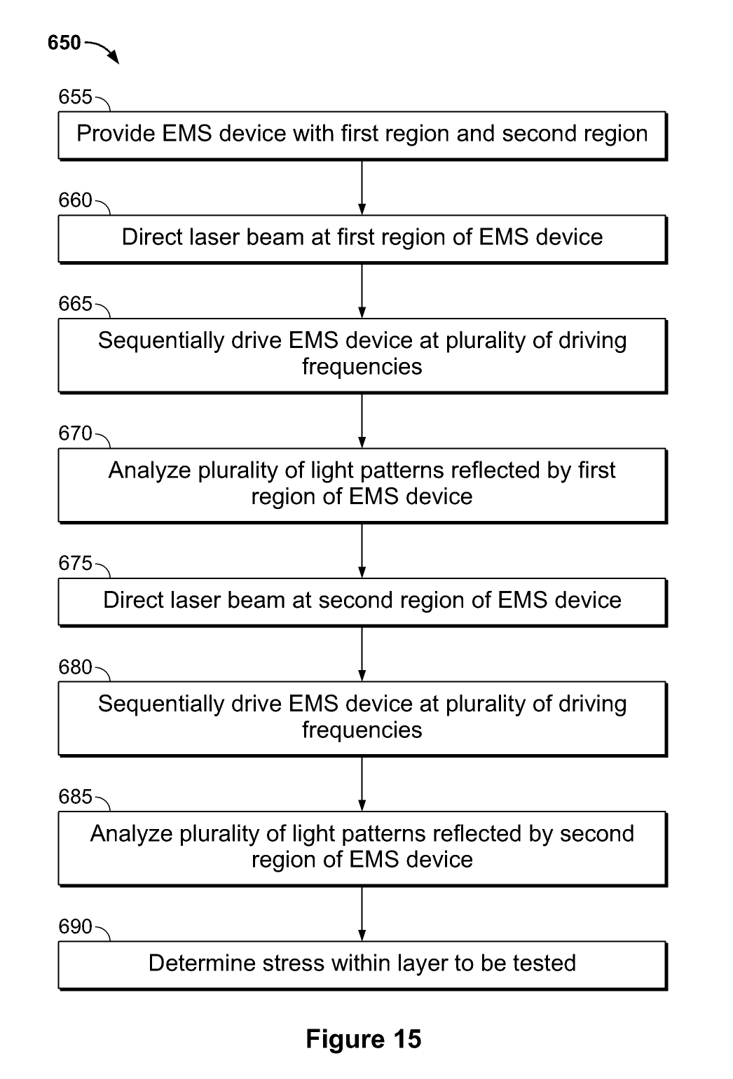

FIG. 15 shows an example of a flow diagram illustrating a method of testing an EMS device to determine a stress within movable component within the EMS device. The method 650 begins at a block 655, wherein an EMS device such as EMS device 600 of FIG. 14 is provided, including a first region including a movable component which includes the layer to be tested, and a second region including a movable component which omits the layer to be tested.

The method 650 proceeds to a block 660, where a laser beam is directed at the first region of the EMS device. The method 650 proceeds to a block 665, where the EMS device is sequentially driven by a periodic voltage at a plurality of driving frequencies. As discussed above, the laser beam is reflected in a light pattern indicative of the movement of the movable component within the first region of the EMS device. The method 650 then proceeds to a block 670, wherein the plurality of light patterns reflected from the first region of the EMS device when driven at the plurality of driving frequencies are analyzed to determine a resonant frequency of the movable component within the first region of the EMS device.

The method 650 then proceeds to a block 675, where a laser beam is directed at the second region of the EMS device. The method 650 proceeds to a block 680, where the EMS device is sequentially driven by a periodic voltage at a plurality of driving frequencies. As discussed above, the laser beam is reflected in a light pattern indicative of the movement of the movable component within the second region of the EMS device. The method 650 then proceeds to a block 685, wherein the plurality of light patterns reflected from the second region of the EMS device when driven at the plurality of driving frequencies are analyzed to determine a resonant frequency of the movable component within the second region of the EMS device.

After the resonant frequencies of the movable components within the first and second regions of the EMS device have been determined, the method 650 proceeds to a block 690 where a stress within the layer to be tested is determined based at least in part on the resonant frequencies of the movable components within the first and second regions of the EMS device. This determination may be based, for example, on the relationship of Equation (13) discussed above.

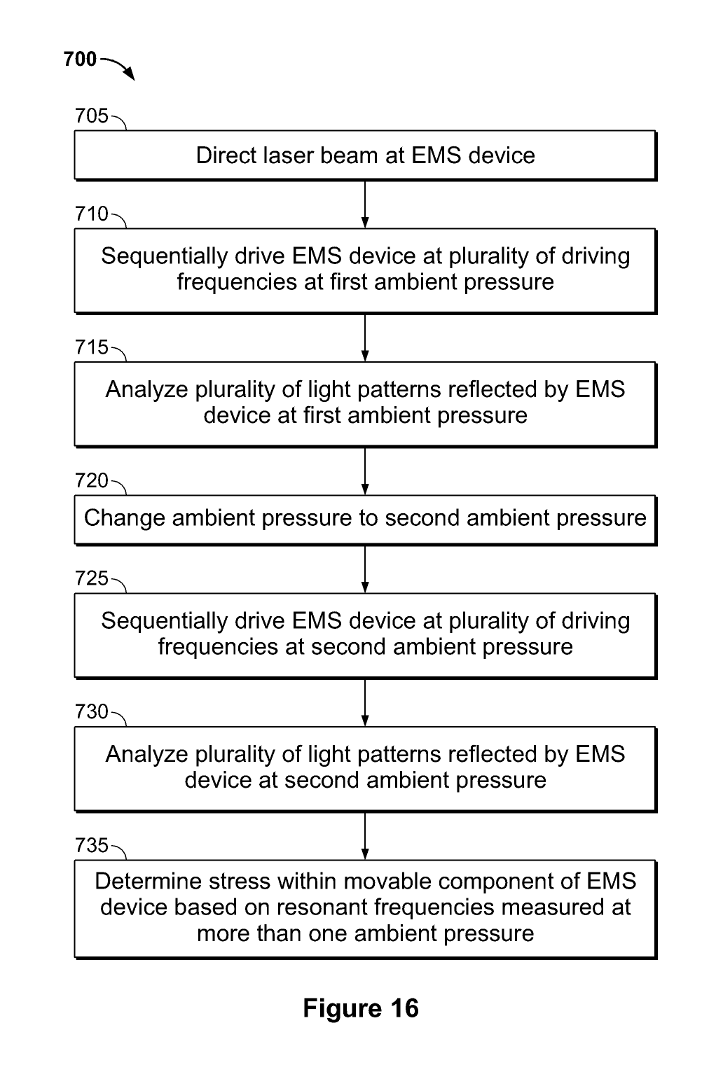

FIG. 16 shows an example of a flow diagram illustrating a method of testing an EMS device to determine the stress within a movable component of the EMS device. The method 700 begins at a block 705 where a laser beam is directed at an EMS device disposed within a chamber which allows the ambient pressure to which the EMS device is exposed to be controlled. The method 700 proceeds to a block 710 where the EMS device is sequentially driven by a periodic voltage at a plurality of driving frequencies while exposed to a first ambient pressure. The method 700 proceeds to a block 715 where the light pattern reflected at each of the plurality of driving frequencies is analyzed to determine the resonant frequency of the movable component within the EMS device at the first ambient pressure.

The method 700 proceeds to a block 720, where the ambient pressure is changed to a second ambient pressure. Then, the method 700 proceeds to a block 725, where the EMS device is sequentially driven by a periodic voltage at a plurality of driving frequencies. The method then proceeds to a block 730 where the light pattern reflected at each of the plurality of driving frequencies is analyzed to determine the resonant frequency of the movable component within the EMS device at the second ambient pressure.

In some implementations, the process 700 may include further repetition of the above steps at additional ambient pressures. Eventually, the process 700 proceeds to a block 735 where the stress within the movable component of the EMS device is determined based at least in part upon the measured resonant frequencies measured at each of the plurality of ambient pressures. In an implementation in which the movable component is a movable film stack including i layers, each having a thickness t and a stress σ, the sum of the product of the stresses σ and the thickness t of each of the films is given by the following relationship, where the resonant frequency ωₐ at each of two ambient pressures Pₐ₁ and Pₐ₂ is known:

$$\begin{matrix}{\sum }_{i}^{ } ( {σ}_{i} {t}_{i} ) = 2 m \cdot ( {ω}_{a}^{2} {\vert}_{{P}_{a 1}} + {ω}_{a}^{2} {\vert}_{{P}_{a 2}} ) - \frac{{μ}_{g}^{2} \cdot {ω}^{2} \cdot {l}^{6}}{{h}_{0}} ( f ( {P}_{a 1} ) + f ( {P}_{a 2} ) ) , \\ where \text{:} & ( 14 ) \\ f ( {P}_{a} ) = {\sum }_{m , {n}_{odd}}^{ } \frac{{P}_{a}}{m \cdot {n}^{2} \{ 2 \cdot {P}_{a}^{2} \cdot {h}_{0}^{4} \cdot {n}^{4} + 72 {μ}_{g}^{2} \cdot {ω}^{2} \cdot {l}^{4} \}} . & ( 15 )\end{matrix}$$

Based upon the above relationships or a similar model for a given EMS device, the total stress within a movable component formed of a thin film stack including i sublayers can be determined based upon a determination of the resonant frequency of the movable component at each of a plurality of different pressures.

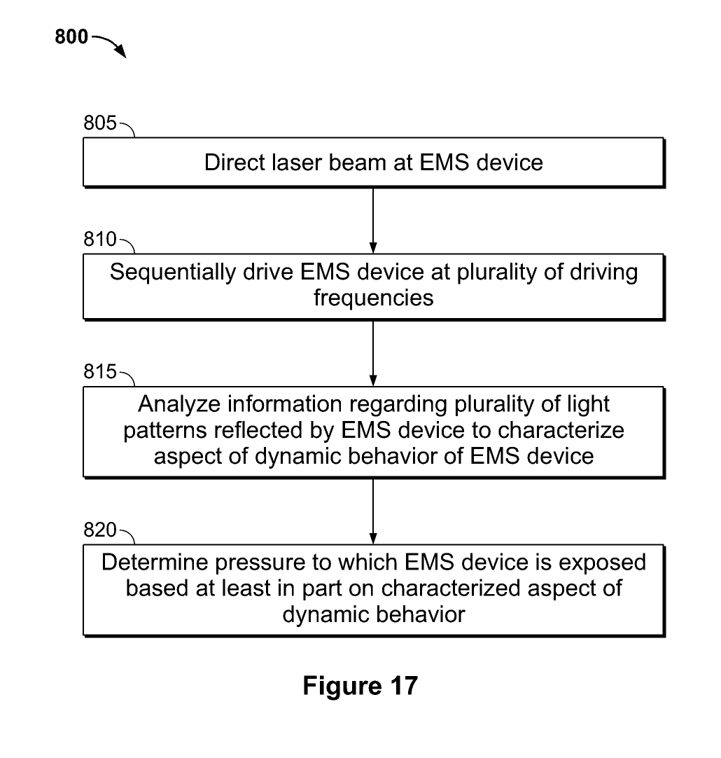

FIG. 17 shows an example of a flow diagram illustrating a method of testing an EMS device to determine the pressure to which the EMS device is exposed. The method 800 begins at a block 805 where a laser beam is directed at a EMS device. The EMS device may be exposed to the ambient, or may be packaged within a sealed package permitting the EMS device to operate in an environment in which the pressure is higher or lower than the ambient pressure. The method 800 then proceeds to a block 810 where the EMS device is sequentially driven by a periodic voltage at a plurality of driving frequencies. As discussed above, the laser beam is reflected in a light pattern indicative of the movement of a movable component within the EMS device, and information regarding these reflected light patterns may be recorded and stored for later analysis.

The method 800 then proceeds to a block 815 where information regarding the reflected light patterns is analyzed in order to characterize an aspect of the dynamic behavior of the EMS device. In one implementation, the peak intensity of the reflected light pattern at each of the plurality of driving frequencies may be used to determine the resonant frequency of the movable component within the EMS device. In another implementation, the phase shift at each of the plurality of driving frequencies may be used to determine the resonant frequency of the movable component within the EMS device. In another implementation, the peak intensity at each of the peak intensity of the reflected light pattern at each of the plurality of driving frequencies may be used to characterize the displacement of the movable component within the EMS device.

The method 800 then proceeds to a block 820, where the pressure to which the EMS device is exposed is determined based at least in part on the characterized aspect of the dynamic behavior of the EMS device. In one implementation, the resonant frequency of the movable component within the EMS device is compared with calibration data regarding a previously measured resonant frequency of the EMS device at a known data point. In a particular implementation, the measured frequency may be used in conjunction with a predictive model of resonant frequency as a function of pressure. In another implementation, the measured frequency can be compared to prior measurements at known pressures of the EMS device or a similar EMS device to determine the pressure to which the EMS device is exposed. In some implementations, the measured frequency can be used in conjunction with a lookup table, where the lookup table can be based either on a predictive model or algorithm or on actual test data.

Similarly, the maximum displacement of the movable component can be determined based on the peak intensity of the reflected light pattern at each of the plurality of driving frequencies. This maximum displacement at each of a plurality of driving frequencies can be used in conjunction with a model of the dynamic behavior of the EMS device to determine the damping forces acting on the movable component of the EMS device, such as by determining the damping coefficient c_{d} of Equation (5) above. The determined damping forces can be used in conjunction with calibration data based on measurements at a known pressure to determine the current pressure to which the EMS device is exposed. As above, the pressure may be determined using a lookup table which correlates damping information with pressure, and the lookup table may be populated using either predicted or measured data.

In other implementations, the process 800 may omit certain steps described above, or may include alternate steps. For example, in certain implementations, the pressure to which the EMS device is exposed is not calculated. In one implementation, the damping forces acting on the EMS device or other information regarding the damping of the EMS device, such as the damping coefficient c_{d}, may be determined based at least in part on the resonant frequency of the movable component within the EMS device.

In another implementation, the difference between the current values of the resonant frequency or the damping forces and the values of the resonant frequency or the damping forces at a known pressure are calculated. If the difference exceeds a particular threshold, it can be determined that an EMS device package has suffered a loss of hermeticity. In a particular implementation, the hermeticity of the package may be tested by placing a hermetically sealed package within a chamber and changing the pressure within the chamber to be either higher or lower than the pressure within the package. The resonant frequency or information regarding the damping forces can be determined shortly after the change in pressure, and then at one or more additional points in time, after the package has been exposed to the pressure differential. If the resonant frequency or the damping forces acting on the EMS device have changed, the pressure within the EMS device package has changed, and the package can be identified as not hermetically sealed, even without determining the current pressure within the EMS device package.

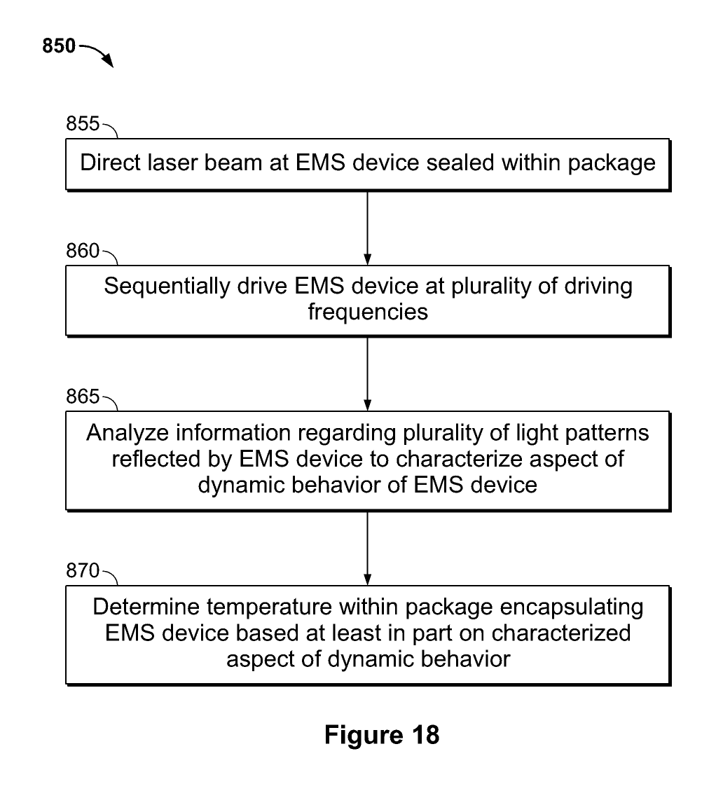

FIG. 18 shows an example of a flow diagram illustrating a method of testing an EMS device to determine the temperature within a package encapsulating an EMS device. The method 850 begins at a block 855 where a laser beam is directed at an EMS device sealed within a package. The method 850 proceeds in a manner similar to method 800 of FIG. 17, moving next to a block 860 where the EMS device is sequentially driven by a periodic voltage at a plurality of driving frequencies. The process 850 then proceeds to a block 865 where information regarding reflected light patterns is analyzed in order to characterize an aspect of the dynamic behavior of the EMS device. As discussed above with respect to process 800 of FIG. 17, the aspect of the dynamic behavior may include the resonant frequency of the EMS device or the damping forces acting on the EMS device.

The process 850 then proceeds to a block 870 where the temperature within the package encapsulating the EMS device is determined based at least in part on the characterized aspect of the dynamic behavior of the EMS device. As discussed above with respect to determination of the pressure to which an EMS device is exposed, a predictive model of the behavior of the EMS device as a function of temperature may be used in conjunction with calibration data measured at a known temperature to determine the current value of the temperature within the package encapsulating the EMS device. As discussed above with respect to FIG. 17, the measured frequency or damping information can be compared to prior measurements at known temperatures of the EMS device or a similar EMS device to determine the temperature within the package. In some implementations, the measured frequency or damping information can be used in conjunction with a lookup table, and the lookup table can be based either on a predictive model or algorithm or on actual test data.

Testing devices such as the testing devices 300 and 400 of FIGS. 10 and 11, respectively, may be used in conjunction with other non-invasive methods of testing EMS devices in order to provide information about the EMS devices. For example, a laser beam may be directed at an undriven EMS element located adjacent an EMS element being driven with a periodic driving voltage signal to provide a measure of the “crosstalk” effect of driving an EMS element on adjacent EMS elements. In another implementation, the testing device may be used to determine the displacement of a movable component of an EMS device as a function of time based at least in part upon the reflected light pattern when a laser beam is incident upon a driven EMS device. As noted above, such testing devices may be used to test EMS devices from either side of the EMS device, and may be used to test packaged or unpackaged EMS devices.

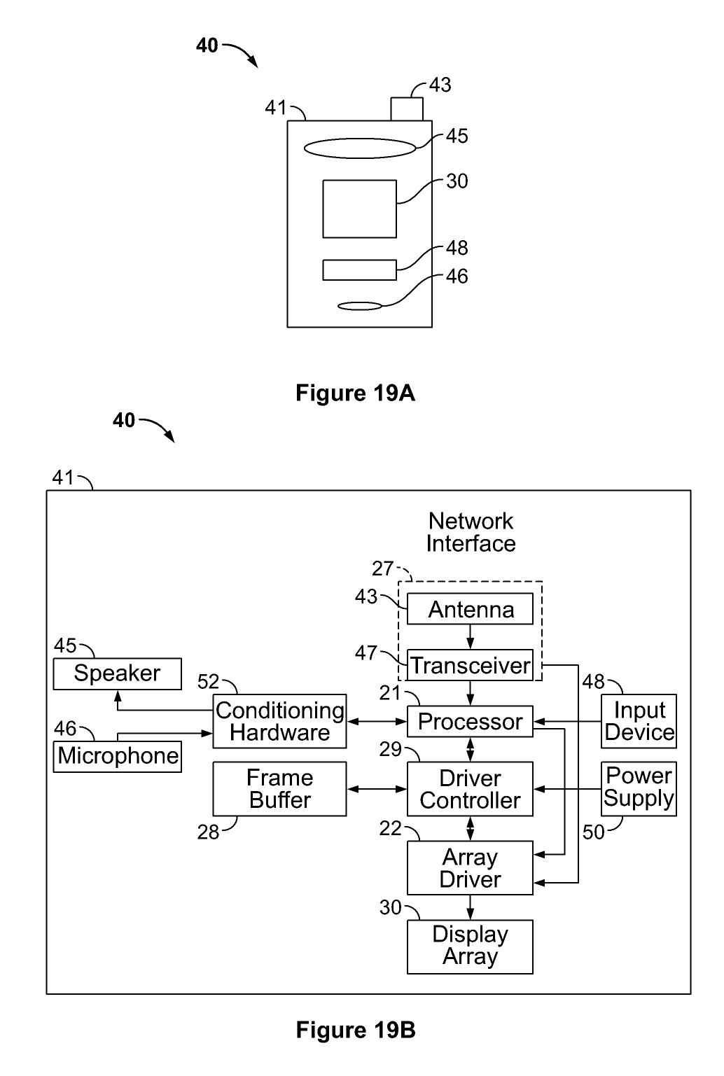

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A testing apparatus for measuring the resonant frequency of an electromechanical systems (EMS) device, the apparatus comprising:
a laser emitting device configured to emit a laser beam;
a first beam directing optic configured to redirect the laser beam towards an EMS device;
a first focusing optic configured to focus the laser beam onto the EMS device;
a second beam directing optic configured to redirect a light pattern reflected from the EMS device; and
a light detection sensor configured to sense the reflected light pattern.

2. The apparatus of claim 1, further comprising a processor, wherein the processor is configured to:
analyze the reflected light pattern sensed by the light detection sensor; and
determine a resonant frequency of the EMS device based at least in part on the reflected light pattern.

3. The apparatus of claim 2, wherein the processor is further configured to determine a damping constant of the EMS device based at least in part on the reflected light pattern.

4. The apparatus of claim 2, wherein the processor is further configured to determine a pressure within a package encapsulating the EMS device based at least in part on the resonant frequency of the EMS device.

5. The apparatus of claim 2, wherein the processor is further configured to determine a temperature within a package encapsulating the EMS device based at least in part on the resonant frequency of the EMS device.

6. The apparatus of claim 2, wherein the processor is further configured to determine a stress within a movable membrane within the EMS device based at least in part on the resonant frequency of the EMS device.

7. The apparatus of claim 2, wherein the processor is further configured to determine a resonant frequency of the EMS device based at least in part on a peak intensity of the reflected light pattern.

8. The apparatus of claim 2, wherein the processor is further configured to determine a resonant frequency of the EMS device based at least in part on a phase shift between a driving signal acting on the EMS device and the response of the EMS device to the driving signal.

9. The apparatus of claim 1, further comprising:
a filtering device configured to filter the reflected light pattern to remove non-collimated light and form a filtered reflected light pattern;
a second focusing optic configured to focus the reflected light pattern on said filtering device; and
a third focusing optic configured to focus the filtered reflected light pattern onto the light detection sensor.

10. The apparatus of claim 1, wherein the second beam directing optic includes an aperture, and wherein the first beam directing optic is configured to direct the laser beam along a first laser path between the first beam directing optic and the EMS device, the first laser path passing through the aperture in the second beam directing optic.

11. The apparatus of claim 10, wherein the second beam directing optic includes a reflective surface surrounding the aperture, wherein the reflective surface is configured to redirect the light pattern reflected from the EMS device.

12. The apparatus of claim 10, wherein the first laser path is offset from a center of the aperture.

13. The apparatus of claim 10, further comprising a camera, wherein the camera is oriented along a camera path extending from the camera to the EMS device, and wherein the camera path is parallel to and offset from the first laser path.

14. The apparatus of claim 1, wherein the laser emitting device emits a monochromatic laser beam.

15. The apparatus of claim 14, wherein the first beam directing optic is a dichroic reflector configured to reflect light of the same wavelength as the monochromatic laser beam.

16. The apparatus of claim 14, further comprising a camera, wherein the camera is oriented along a camera path extending from the camera to the EMS device, and wherein the camera path passes through the dichroic reflector.

17. A testing apparatus for measuring the resonant frequency of an electromechanical systems (EMS) device, the apparatus comprising:
a laser emitting device configured to emit a laser beam;
a first beam directing optic configured to redirect the laser beam towards an EMS device;
a first focusing optic configured to focus the laser beam onto the EMS device;
a second beam directing optic configured to redirect a light pattern reflected from the EMS device; and
means for sensing the reflected light pattern.

18. The testing apparatus of claim 17, wherein the sensing means includes a light detection sensor configured to sense the reflected light pattern.

19. The testing apparatus of claim 18, further comprising a processor configured to:
analyze the reflected light pattern sensed by the light detection sensor; and
determine a resonant frequency of the EMS device based at least in part on the reflected light pattern.

20. The testing apparatus of claim 19, further comprising:
a filtering device configured to filter the reflected light pattern to form a filtered reflected light pattern;
a second focusing optic configured to focus the reflected light pattern on said filtering device; and
a third focusing optic configured to focus the filtered reflected light pattern onto the light detection sensor.

21. The testing apparatus of claim 19, wherein the laser emitting device emits a monochromatic laser beam.

22. The testing apparatus of claim 21, wherein the first beam directing optic is a dichroic reflector configured to reflect light of the same wavelength as the monochromatic laser beam.

23. The testing apparatus of claim 19, wherein the second beam directing optic includes an aperture, and wherein the first beam directing optic is configured to direct the laser beam along a first laser path between the first beam directing optic and the EMS device, the first laser path passing through the aperture in the second beam directing optic.

24. A method of testing an electromechanical systems (EMS) device to determine a resonant frequency of the EMS device, the method comprising:
directing a laser beam at an EMS device;
driving the EMS device with a periodic electrical signal to cause movement of at least one portion of the EMS device relative to other portions of the EMS device;
varying the frequency of the periodic electrical signal; and
analyzing a plurality of light patterns reflected from the EMS device when driven at a plurality of driving frequencies to determine a resonant frequency of the EMS device.

25. The method of claim 24, further comprising sensing the plurality of light patterns reflected from the EMS device with a light detection sensor.

26. The method of claim 24, wherein determining the resonant frequency of the EMS device comprises:
determining a frequency response of the EMS device at each of the plurality of driving frequencies based at least in part on the light pattern reflected from the EMS device when driven at each of the plurality of driving frequencies; and
determining a resonant frequency based at least in part on the frequency response at each of the plurality of driving frequencies.

27. The method of claim 24, wherein directing a laser beam at the electromechanical systems device includes directing a monochromatic laser beam at the electromechanical systems device.

28. The method of claim 24, wherein the EMS device is encapsulated within a package, the method further including determining at least one of: a pressure within the package based on the resonant frequency of the EMS device and a temperature within the package based at least in part on the resonant frequency of the EMS device.

29. The method of claim 24, wherein the EMS device includes at least one movable membrane, the method further including determining a stress of the movable membrane based at least in part on the resonant frequency of the electromechanical systems device.

30. A non-transitory, computer readable storage medium comprising instructions which, when executed by one or more processors, cause a computer to perform a method as recited in claim 24.
